(19) United States
(12) Patent Application Publication
(10) Pub. No.: US 2008/0309043 A1
(43) Pub. Date: Dec. 18, 2008

(54) Suspension using leverage

(76) Inventor: Man Hee Jeong, Wonju-si (KR)

Correspondence Address: BACON & THOMAS, PLLC, 625 SLATERS LANE, FOURTH FLOOR, ALEXANDRIA, VA, 22314-1176, US

(21) Appl. No.: 12/213,406

(22) Filed: Jun. 19, 2008

Related U.S. Application Data
(63) Continuation of application No. 11/808,795, filed on Jun. 13, 2007.

(51) Int. Cl. B60G 17/00

(52) U.S. Cl. 280/124.1

(57) ABSTRACT

Disclosed is a suspension using continuous and variable leverage, in which a lever serves as a substitute for an air spring. First, a fulcrum located at the center of the lever is connected to a chassis of a vehicle. An impact transmission plate, which has a convex shape toward the lever and is connected to the upper end of a supporter connected integrally with a non-rotating wheel shaft of a wheel, is located under one end of the lever, and transmits an impact from the wheel to the lever. A spring connected to the other end of the lever absorbs the impact transmitted through the lever. The stronger the impact transmitted from the wheel is, the higher the impact transmission plate pushes up the lever. Then, since the upper surface of the impact transmission plate has a convex shape toward the lever, a pressure point, i.e., a contact point between the lever and the impact transmission plate, is shifted toward the fulcrum of the lever. The shift of the pressure point generates an effect, as if the repulsive force of the spring is increased. The suspension has a structure, which exhibits a low spring constant against a weak impact and exhibits a high spring constant against a strong impact, and thus concurrently provides excellent ride comfort and running safety regardless of degrees of the unevenness of a road surface.

### CROSS REFERENCE TO THE RELATED APPLICATION

This application is being filed as a continuation-in-part of Ser. No. 11/808,795 entitled SHOCK ABSORBER, which was filed on Jun. 13, 2007.

### BACKGROUND OF THE INVENTION

1. Field of the Invention

The present invention relates to a suspension using leverage, and more particularly to a suspension, which uses a general spring made of steel but obtains a result as if a spring constant is changed in real time according to intensities of impact, and thus concurrently obtains excellent ride comfort and running safety regardless of the degree of unevenness of a road surface.

2. Description of the Related Art

Generally, vehicles use a suspension to alleviate various impacts generated during driving. The suspension includes a spring to alleviate an impact transmitted from a road surface, a shock absorber to absorb the vibration of the spring, and a stabilizer bar to prevent a vehicle from shaking from side to side.

A coil spring, which is mainly used in the conventional suspension, has a regular spring constant. Thus, in case that a soft coil spring is used, ride comfort is excellent but running safety is lowered, i.e., a vehicle on a curved road leans to one side due to centrifugal force, and in case that a strong coil spring is used, running safety of a vehicle is obtained but ride comfort is lowered. Other springs have the same phenomenon. That is, although any conventional spring is used, sufficient ride comfort and running safety cannot be obtained concurrently.

In order to solve the above problem to some extent, an air spring is used. The air spring does not comply with Hooke's Law (F=kx) but complies with Boyle-Charles's Law (PV/T=regular) in view of characteristics of a material, i.e., air, and more easily obtains ride comfort and running safety than a spring made of steel. In order to examine a difference of ride comfort and running safety between an air spring and a steel spring, a contraction test was carried out.

For example, in case that a steel spring, which can contract to a length of 37 cm, was prepared and supported a weight of 5 tons, when the contracted length of the steel spring due to the weight was 17 cm, a spare length of the steel spring, which is contractible, was 20 cm. Thereafter, in case that a weight of 1 ton was added to the steel spring, the contractible spare length of the steel spring was 16.6 cm based on Hooke's Law. Further, in case that a weight of 2 tons was added to the steel spring, the space length was 13.2 cm, and in case that a weight of 3 tons was added to the steel spring, the spare length was 9.8 cm, and in case that a weight of 4 tons was added to the steel spring, the spare length was 6.4 cm.

In the same manner, when a proper air spring (cylinder-type) was prepared and supported a weight of 5 tons, the height of a portion of the air spring filled with air was 20 cm. in case that a weight of 1 ton was added to the air spring, the height of the portion of the air spring was reduced to 16.6 cm based on Boyle-Charles's Law. Further, in case that a weight of 2 tons was added to the air spring, the height was reduced to 14.3 cm, and in case that a weight of 3 tons was added to the air spring, the height was reduced to 12.5 cm, and in case that a weight of 4 tons was added to the air spring, the height was reduced to 1.1 cm. This is shown in Graph 1, as follows.

Graph 1 shows that the steel spring is contracted in direct proportion to a weight applied to the steel spring but the contracted degree of the air spring is gradually decreased. When a load of 1 ton is applied to the steel spring and the air spring, the contracted lengths of both the steel spring and the air spring were 3.4 cm, but when a load of 4 tons is added to the steel spring and the air spring, the contracted length of the steel spring was 13.6 cm but the contracted length of the air spring was 8.9 cm.

In view of material characteristics, although the steel spring and the air spring are designed to provide the same ride comfort, it is known that the air spring has higher running safety than that of the steel spring. The reason is that the steel spring maintains the same spring constant regardless of the compressed degree of the steel spring but the air spring has a spring constant, which is gradually increased as the compression of the air spring is progressed.

Since a clear theory regarding the repulsive force of an ideal suspension for vehicles is not founded yet, the interrelation between the repulsive force and the impact absorbing distance of the ideal suspension is based on present road conditions and numerical values by experience. Preferably, the ideal suspension is softly operated in the initial range of 2 cm, and absorbs all impacts at a distance within approximately 5-6 cm, although a large impact is applied to the suspension as a vehicle goes over an overspeed prevention sill.

Since real road surfaces mostly have unevenness having a height lower than 1 cm, when the rebounded height of a wheel is not more than 2 cm, if a spring is smoothly operated, ride comfort is good. Further, from when the impact absorbing distance exceeds 2 cm, the repulsive force of the spring is increased and if the suspension absorbs an impact having the same level as that when a vehicle goes over an overspeed prevention sill at the overall impact absorbing distance of 56 cm (the impact absorbing distance of the suspension when the vehicle goes over the overspeed prevention sill), it is possible to sufficiently suppress the leaning of the vehicle. A variation of the repulsive force of a spring for obtaining this ideal impact absorbing action is shown in Graph 2, as follows.

In a curve illustrating the ideal suspension in Graph 2, a portion, in which a value of the X-axis is low, is a section exhibiting excellent ride comfort, and thereafter, the rapidly increased repulsive force means that a vehicle scarcely rolls when the vehicle passes by a curved road. The conventional steel spring or air spring cannot achieve a rapid variation of the repulsive force of the spring, as shown in Graph 2.

### SUMMARY OF THE INVENTION

Therefore, the present invention has been made in view of the above problems, and it is an object of the present invention to provide a suspension, which exhibits a low spring constant against a weak impact and exhibits a high spring constant against a strong impact, and thus properly copes with an impact from a wheel according to intensities of the impact even using a soft spring providing ride comfort with a driver's desired degree, thereby concurrently providing excellent ride comfort and running safety to passengers.

In accordance with the present invention, the above and other objects can be accomplished by the provision of a suspension using continuous and variable leverage. The suspension uses a spring made of steel, which has a regular constant, but exhibits an effect as if the spring constant is varied according to intensities of an impact.

Since the conventional springs cannot achieve a rapid variation of a spring constant value in view of material characteristics, the present invention provides a suspension having repulsive force, which is desired by a designer, by a method obtaining an effect as if the spring constant is varied using leverage.

Let me show the FIG. 1. A lever has a fulcrum at the center thereof, and has a point of action and a point of force at both sides of the fulcrum. Now, a distance between the point of force and the fulcrum is expressed by ‘a’, and a distance between the point of action and the fulcrum is expressed by ‘b’. A spring having a designated repulsive force W is disposed at the point of action, and an impact F transmitted from a wheel is applied to the point of force. If an expression of Fa=Wb is satisfied, the lever keeps its balance. Thus, if the distance b between the point of action and the fulcrum is regular but the distance a between the point of force and the fulcrum is decreased, the effect of increasing the repulsive force W of the spring disposed at the point of action can be obtained.

The suspension of the present invention has a structure, which allows the distance b between the point of action and the fulcrum to be regular but the distance a between the point of force and the fulcrum to be continuously varied, so that the repulsive force W of the spring is varied according to intensities of an impact. For this reason, the upper surface of a steel plate (hereinafter, referred to as an ‘impact transmission plate’) transmitting the impact of a wheel to the lever has a convex shape protruding toward the lever such that a contact point (hereinafter, referred to as a ‘pressure point’) between the lever and the impact transmission plate can be continuously shifted toward the center (fulcrum) of the lever as pressurization is progressed.

As pressurization is progressed, the pressure point is shifted toward the fulcrum of the lever but the distance b between the fulcrum and the point of action (the point where the lever transmits force to the spring) is not varied. That is, the distance b is not varied but is fixed but the distance a is changed to a distance a by the shift of the pressure point P, and thus a value of b/a is continuously varied. A variation of the value of b/a results in a variation of a spring constant according to intensities of an impact. Since b is constant and a is a variable, a method for adjusting the repulsive force of the suspension using a lever can achieve the ideal repulsive force, as shown in Graph 2. Fundamentally, a method for causing a variation (Δa) of the distance a to be larger than a variation (Δb) of the distance b is possible.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic view illustrating a basic principle applied to a suspension in accordance with the present invention;

FIGS. 2A and 2B are schematic views of suspensions in accordance with one embodiment of the present invention, which can be mounted on a wheel of a small truck or a bus having a comparatively large space;

FIG. 3 is a schematic view of a suspension in accordance with another embodiment of the present invention;

FIG. 4 is a schematic view of a suspension in accordance with another embodiment of the present invention;

FIGS. 5A and 5B are schematic views of suspensions in accordance with another embodiment of the present invention, illustrating the basic principle shown in FIG. 1;

FIGS. 6A to 6C are schematic views of suspensions, which use a hinge bar instead of a lever, in accordance with another embodiment of the present invention, each illustrating a state of the suspension before leverage is performed and a state of the suspension after the leverage is performed;

FIG. 7 is a schematic view of a suspension in accordance with another embodiment of the present invention, which is mounted on a wheel of a small car having a small mounting space;

FIGS. 8A and 8B are exemplary views illustrating suspensions of the present invention, which are applied to a conventional leaf spring;

FIGS. 9A and 9B are schematic views of suspensions using a lever having one end with a leaf spring such that the lever can absorb an impact; and

FIG. 10 is a schematic view of a suspension with a leaf spring having one end fixed to a chassis of a vehicle such that the leaf spring can absorb an impact.

### DESCRIPTION OF THE PREFERRED EMBODIMENTS

Now, preferred embodiments of the present invention will be described in detail with reference to the annexed drawings.

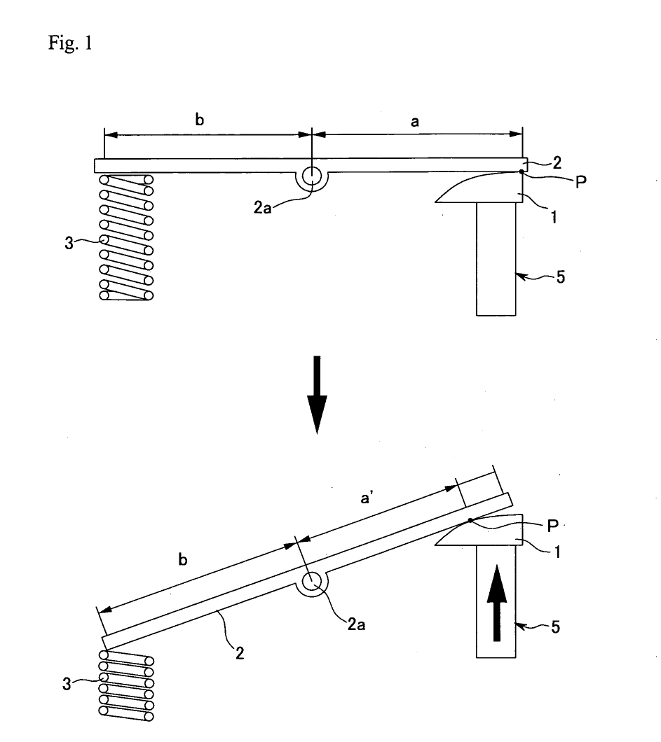

FIG. 1 is a schematic view illustrating a basic principle applied to a suspension in accordance with the present invention. A chassis of a vehicle is connected to a lever 2 through a fulcrum 2a of the lever 2. A supporter 5 firmly fixed to a non-rotating wheel shaft of a wheel transmits the vibration of the wheel to the lever 2. A spring 3 absorbs the impact transmitted to the lever 2. When the support 5 transmits the impact to the lever 2 due to the up-and-down shaking of the wheel running on a rough road surface, the stronger the impact is, the higher an impact transmission plate 1 pushes up the lever 2. Since the upper surface of the impact transmission plate 1 has a convex shape protruding toward the lever 2, a pressure point P, at which the lever 2 and the impact transmission plate 1 contact each other, is shifted toward the fulcrum 2a of the lever 2.

As described above, the suspension of the present invention includes the impact transmission plate 1 having a lower end connected to the non-rotating wheel shaft of a wheel of a vehicle and an upper end contacting the lever 2, the lever 2 having one end contacting the impact transmission plate 1 and connected to a chassis through the fulcrum 2a, and an impact absorbing part (spring) 3 connected to the other end of the lever 2 and absorbing an impact transmitted through the lever 2 when the wheel is shaken up and down. Here, the upper surface of the impact transmission plate 1 or the lever 2 contacting the impact transmission plate 1 has a convex shape such that the pressure point P is shifted toward the center of the lever 2 as pressurization is progressed.

The increase of a spring constant as the impact is increased is caused by the convex shape of the upper surface of the impact transmission plate 1, contacting the lever 2, toward the lever 2. The basic principle of the present invention is that the impact absorbing part (spring) exhibits a weak repulsive force against a weak impact and exhibits a strong repulsive force against a strong impact through the continuous shift of the position of the pressure point P, at which the convex upper surface of the impact transmission plate 1 and the lever 2 contact each other.

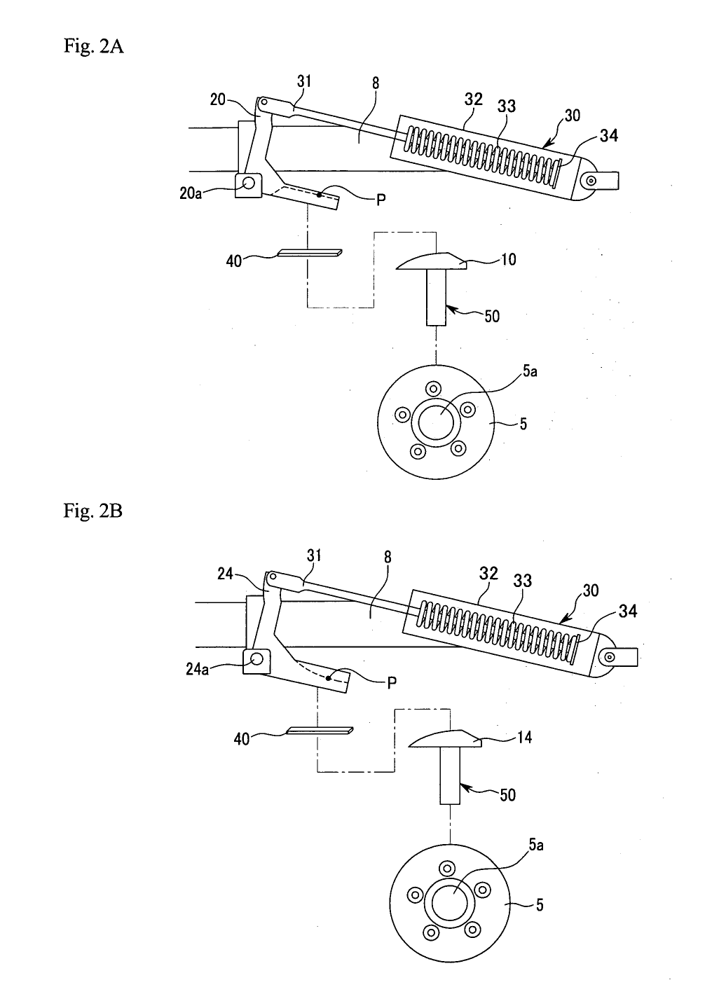

FIGS. 2A and 2B illustrate suspensions in accordance with one embodiment of the present invention, which are mounted on a rear wheel of a small truck. As shown in FIG. 2A, a fulcrum 20a of a lever 20 is fixed to a chassis of a vehicle, and the weight of the vehicle is transmitted to the ground through the fulcrum 20a. A spring 33 or an elastic body to absorb an impact is disposed at one end of the lever 20, thus forming an impact absorbing part 30. The impact absorbing part 30 and the end of the lever 20 are connected, as shown in FIG. 2A, so as not to change a straight distance between the fulcrum 20a of the lever 20 and the impact absorbing part 30. That is, a distance between a point of action (a point transmitting an impact to the impact absorbing part 30) of the lever 20 and the fulcrum 20a is regular at any time. An impact transmission plate 10 contacting the other end of the lever 20 is firmly fixed to a non-rotating wheel shaft of a wheel 5 through a supporter 50. Further, the upper surface of the impact transmission plate 10 contacting the lever 20 has a convex shape protruding toward the lever 20.

In the above suspension, when the wheel 5 is rebounded due to the unevenness of a road surface, the lever 20 is pushed upward by the impact transmission plate 10 and is rotated in the counterclockwise direction on the fulcrum 20a concurrently, and pulls a rod 31 of the impact absorbing part 30. Thereby, the lever 20 has an elastically repulsive force.

Since the upper surface of the impact transmission plate 10 has a upwardly convex shape and the lever 20 has a straight shape, the impact transmission plate 10 and the lever 20 form one contact point P. When the wheel 5 is rebounded on the road surface, the lever 20 is pushed upward and the contact point P is shifted toward the fulcrum 20a of the lever 20. The spring 33 to absorb an impact obtains an effect, as if it exhibits a low spring constant against a weak impact and exhibits a high spring constant against a strong impact, through the shift of the position of the contact point P. Here, the contact point is the same with a pressure point.

If a horizontal distance between the lever 20 and the impact transmission plate 10 is not changed, when an impact absorbing action is generated, the friction between the lever 20 and the impact transmission plate 10 is produced due to the different shapes of the surfaces of the lever 20 and the impact transmission plate 10, contacting each other. Here, a flat plate 40 serves to minimize the friction.

Further, in a suspension modified from the suspension of FIG. 2A, as shown in FIG. 2B, the upper surface of an impact transmission plate 13 contacting a lever 23 is flat and the lower surface of the lever 23 contacting the flat upper surface of the impact transmission plate 13 has a downwardly convex shape such that a pressure point P is shifted toward a fulcrum 23a as pressurization is progressed. Since the present invention is characterized in that the contact point P between the lever 20 or 23 and the impact transmission plate 10 or 13 is continuously shifted, the contact point P can be continuously shifted if any one of the lever and the impact transmission plate has a convex shape.

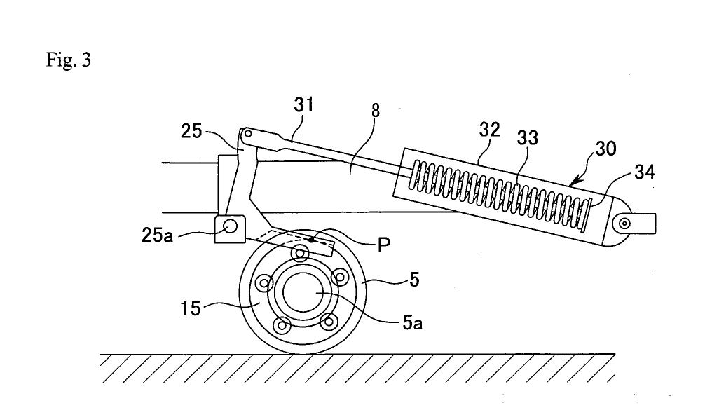

FIG. 3 illustrates a suspension in accordance with another embodiment of the present invention. In this suspension, in order to remove frictional resistance between a lever 25 and an impact transmission plate 15, the impact transmission plate 15 has a rotatable disk shape.

The impact transmission plate 15 has a disk shape, the upper surface of which is convex upwardly, and thus a pressure point P is shifted toward a fulcrum 25a as pressurization is progressed. Further, the impact transmission plate 15 is mounted on a non-rotating wheel shaft 5a of a wheel 5 such that the impact transmission plate 15 has a center of rotation at the center of the non-rotating wheel shaft 5a and surrounds the non-rotating wheel shaft 5a, and has a structure, which can be rotated on the wheel shaft 5a, so as to remove the friction between the lever 25 and the impact transmission plate 15 as pressurization is progressed.

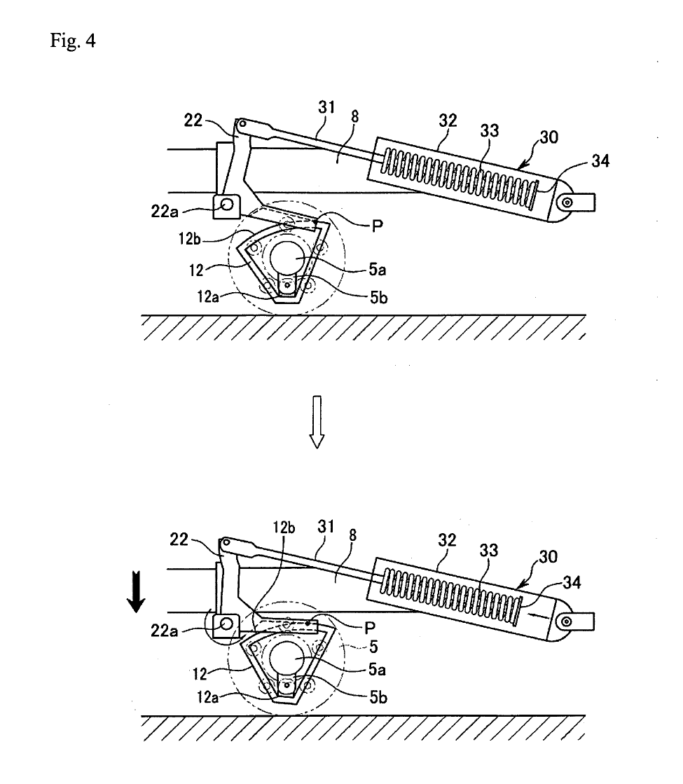

FIG. 4 is a schematic view of a suspension in accordance with another embodiment of the present invention, to reduce a vertical space. The suspension of FIG. 4 includes an impact absorbing part having the same structure as that of the suspension of FIG. 3 and an impact transmission plate 12 having a structure differing from that of the suspension of FIG. 3.

With reference to FIG. 4, separate hinge brackets 5b are formed on the bottom of the non-rotating wheel shaft 5a of a wheel 5. A hinge connection piece 12a hinged to the hinge brackets 5b is formed on the lower end of the impact transmission plate 12, and an upwardly convex rounded curve part 12b is formed on the upper surface of the impact transmission plate 12 such that the impact transmission plate 12 is rotated on the non-rotating wheel shaft 5a and a pressure point P between the impact transmission plate 12 and a lever 22 is shifted toward a fulcrum 22a as pressurization onto the lever 22 is progressed.

Here, the impact transmission plate 12 has the shape of a hollow polygonal frame such that the non-rotating wheel shaft 5a passes through the impact transmission plate 15, the hinge connection piece 12a having the shape of a piece plate protrudes upwardly from the inner surface of the lower end of the impact transmission plate 12, and the hinge brackets 5b corresponding to the hinge connection piece 12a respectively have the shape of a pair of piece plates separated from each other by a designated distance such that the hinge brackets 5b can cover the hinge connection piece 12a from both sides and be hinged to the hinge connection piece 12a.

When a distance between the shaft 22a of the lever 22 and the pressure point P, i.e., an impact transmission point, is 15 cm, in order to shorten an impact absorbing distance, a distance from the curve part 12b of the impact transmission plate 12 to a rotating shaft 12a may exceed 40 cm, although the distance varies according to the design. Thus, a vertical space needs to be reduced and an angle of rotation required by operation may be small. The polygonal frame shape of the impact transmission plate 12 satisfies these requirements.

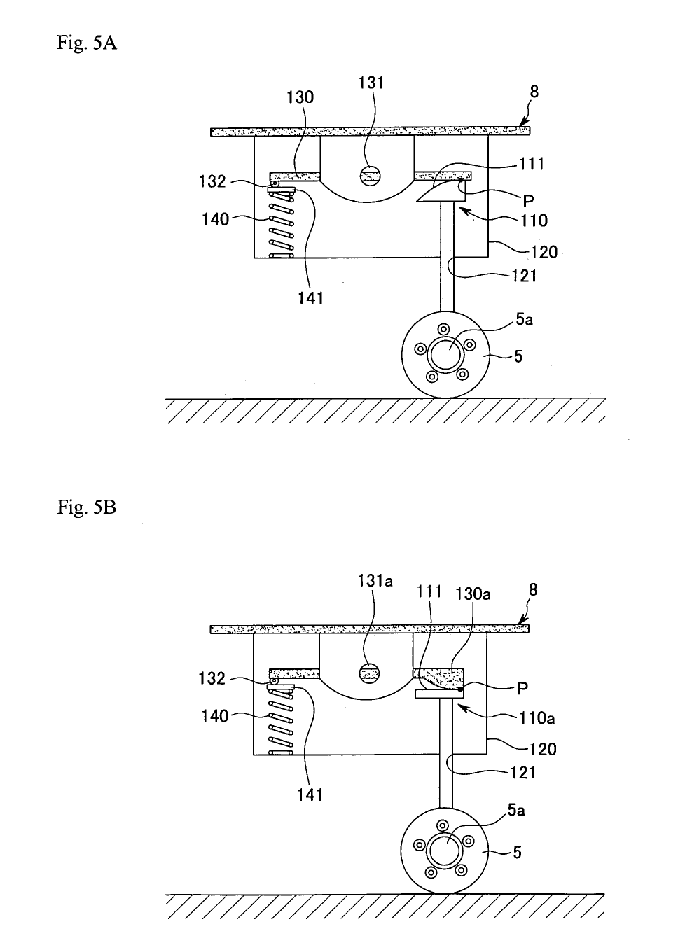

FIGS. 5A and 5B illustrate suspensions in accordance with another embodiment of the present invention. As shown in FIG. 5A, a suspension includes an impact transmission plate 110 fixed directly to a wheel 5, and a housing 120 fixed to a chassis 8 of a vehicle to support a fulcrum 131 of a lever 130 and a spring 140. The suspension is characterized in that a flat plate fixes the fulcrum 131 and the housing 120 prevents the separation of the spring 140. A curve part 111, which is gently curved toward the fulcrum 131, is formed on the upper surface of the impact transmission plate 110 such that a pressure point P between the impact transmission plate 110 and the lever 130 is shifted toward the fulcrum 131 as pressurization onto the lever 130 is progressed.

Preferably, a flat plate 141 to pressurize the spring 140 is installed on the lower surface of the lever 130 pressurizing the spring 140, and a rotating roller 132 to reduce friction in operation is installed between the flat plate 141 and the lever 130. Of course, the rotating roller 132 may be replaced with a sliding bar.

FIG. 5B illustrates a suspension modified from the suspension of FIG. 5A. Here, the upper surface of an impact transmission plate 110a is flat and the lower surface of the lever 130a contacting the flat upper surface of the impact transmission plate 110a has a downwardly convex shape such that a pressure point P between the impact transmission plate 110a and the lever 130a is shifted toward a fulcrum 131a as pressurization onto the lever 131a is progressed.

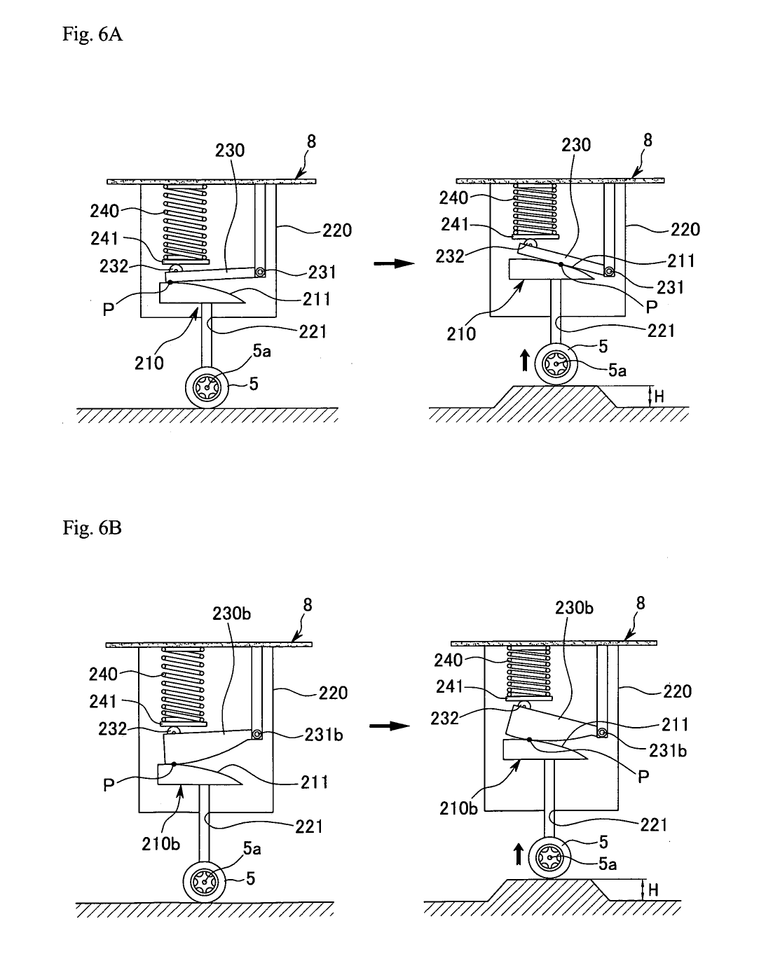

FIGS. 6A to 6C illustrate suspensions in accordance with another embodiment of the present invention. As shown in FIG. 6A, a suspension includes an impact transmission plate 210 having a lower end connected directly to a non-rotating wheel shaft 5a of a wheel 5 and an upper end extended upwardly, a hinge bar 230 having one end with the lower surface contacting the impact transmission plate 210 and the other end with a hinge shaft 231 hinged thereto, and a spring 240 disposed closely between the upper surface of one end of the hinge bar 230 and the upper surface of the housing 220. The housing 220 fixed to a chassis 8 of a vehicle maintains the position of the impact transmission plate 210 when the impact transmission plate 210 is not firmly fixed to the non-rotating wheel shaft 5a of the wheel 5.

A curve part 211, which is gently curved toward the hinge shaft 231, is formed on the upper surface of the impact transmission plate 210 such that a pressure point P between the impact transmission plate 210 and the hinge bar 230 is shifted toward the hinge shaft 231 as pressurization onto the hinge bar 230 130 is progressed. The connection between the spring 240 and the hinge bar 230 serving as a lever is carried out by the method, as shown in FIG. 5A.

The suspension of FIG. 6A is designed for a vehicle having no spatial margin, such as an automobile, and is characterized in that a point of action 232 and a point of force P are not divided into two sides of a rotating shaft 231 of the hinge bar 230 but are formed at one side of the rotating shaft 231.

Now, the operation of the suspension will be described. When the wheel 5 is rebounded on the road surface and the chassis 8 comes down, the pressure point P between the curve part 211 of the impact transmission plate 210 and the hinge bar 230 is shifted toward the hinge shaft 231 and the hinge bar 230 is pushed upward. Thereby, the hinge bar 230 compresses the spring 240 upwardly, and then the spring 240 has an elastically repulsive force and thus reduces a degree of the impact.

FIG. 6B illustrates a suspension modified from the suspension of FIG. 6A. Here, the upper surface of an impact transmission plate 210a contacting a hinge bar 230a is flat and the lower surface of the hinge bar 230a corresponding to the flat upper surface of the impact transmission plate 210a has a downwardly convex shape.

FIG. 6C illustrates a suspension modified from the suspensions of FIGS. 6A and 6B. In order to remove inconvenience of installing a rotating roller or a sliding bar when the spring is compressed, this suspension is configured such that an impact transmission plate is connected directly to a spring. The suspension of FIG. 6C differs from the suspensions of FIGS. 6A and 6B in that a pressure point between an impact transmission plate 210b and a hinge bar 230b becomes distant from a hinge shaft 231b as pressurization onto the hinge bar 230b is progressed. The lower surface of the impact transmission plate 210b contacting the hinge bar 230b has a downwardly convex shape, and a supporter 243 to allow the impact transmission plate 210b only to move up an down at a fixed position is installed. A contact position between a steel rod fixed to a non-rotating wheel shaft of a wheel 5 to transmit an impact and the hinge bar 230b and a position of the hinge shaft 231b are not changed, but the pressure point P becomes distant from the hinge shaft 231b as pressurization is progressed and thus produces the same effect as leverage.

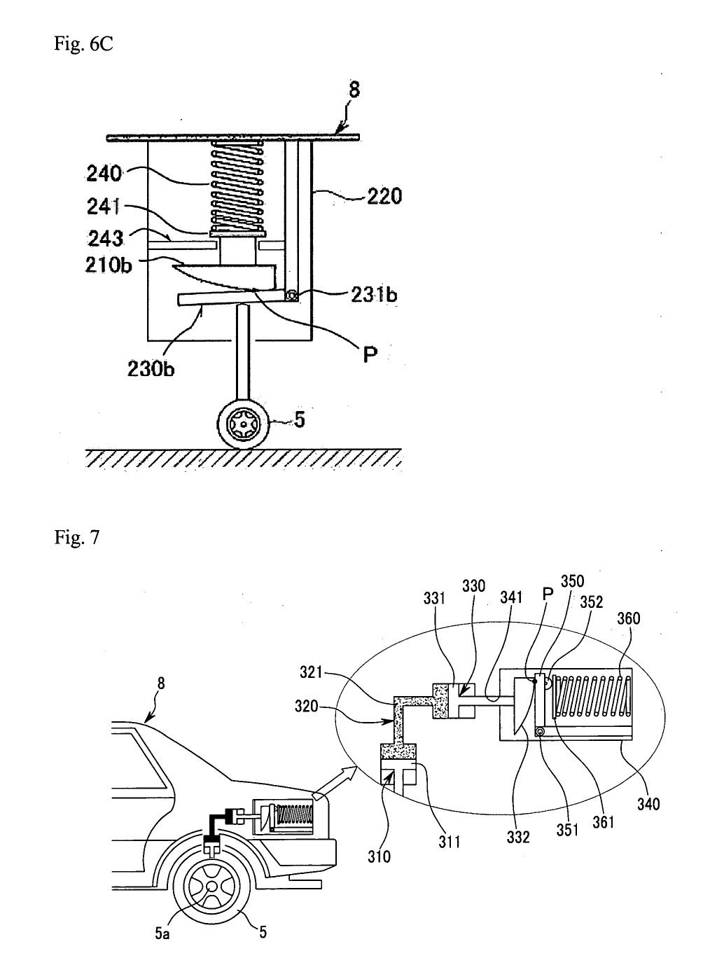

FIG. 7 illustrates a suspension in accordance with another embodiment of the present invention, obtained by applying hydraulic pressure to the suspension of FIG. 6A. When a vertical space to install the suspension is not sufficient, a spring 360 is received in a proper space and an impact is transmitted to the spring 360 using hydraulic equipment, as shown in FIG. 7.

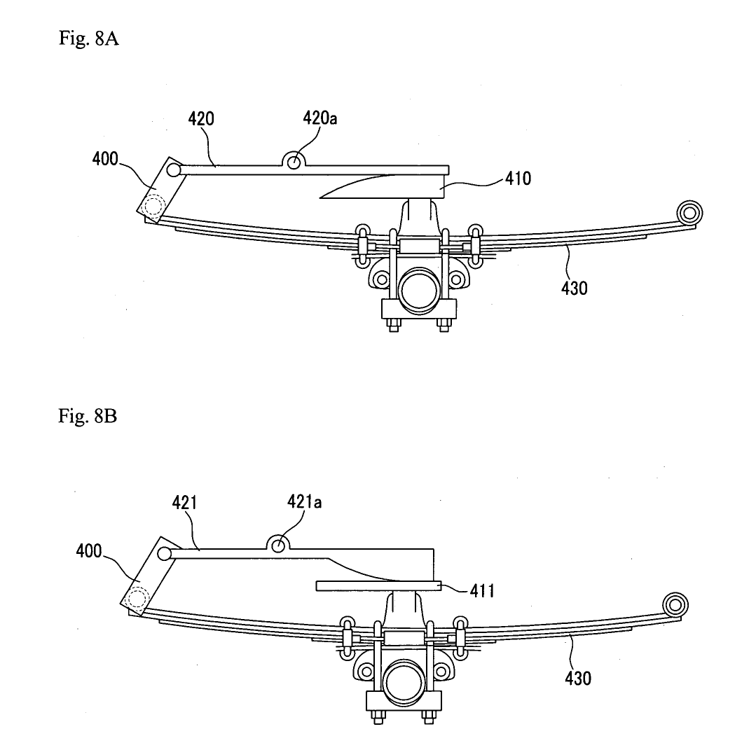

FIGS. 8A and 8B illustrate suspensions of the present invention, which are simply added to a conventional leaf spring. These suspensions have a simple structure obtained by connecting a lever and an impact transmission plate to the leaf spring. The suspensions of the present invention obtain excellent ride comfort and running safety simultaneously, and thus reduce the number of leaf springs used, thereby being economical.

With reference to FIG. 8A, a suspension includes an impact transmission plate 410 having a lower end fixed directly to a leaf spring 430 or a wheel shaft, a lever 420 having one end with the lower surface contacting the impact transmission plate 410 and a fulcrum 420a formed at the center of the lever 420, the fulcrum 420a connected to a chassis of a vehicle to transmit the weight of the vehicle, and the leaf spring 430 connected to the lower surface of the other end of the lever 420 by a hanger 400 and fixed to the wheel shaft. Here, the upper surface of the impact transmission plate 410 has an upwardly convex shape.

When the impact transmission plate 410 presses one side of the lever 420 upwardly due to an impact from the ground, a pressure point P is shifted toward the fulcrum 420a, and thus the opposite side of the lever 420 from the fulcrum 420a presses the hanger 400 downwardly such that the plate spring 430 absorbs the impact. Further, FIG. 8B illustrates a suspension modified from the suspension of FIG. 8A. Here, a convex curve part is formed on a lever 420.

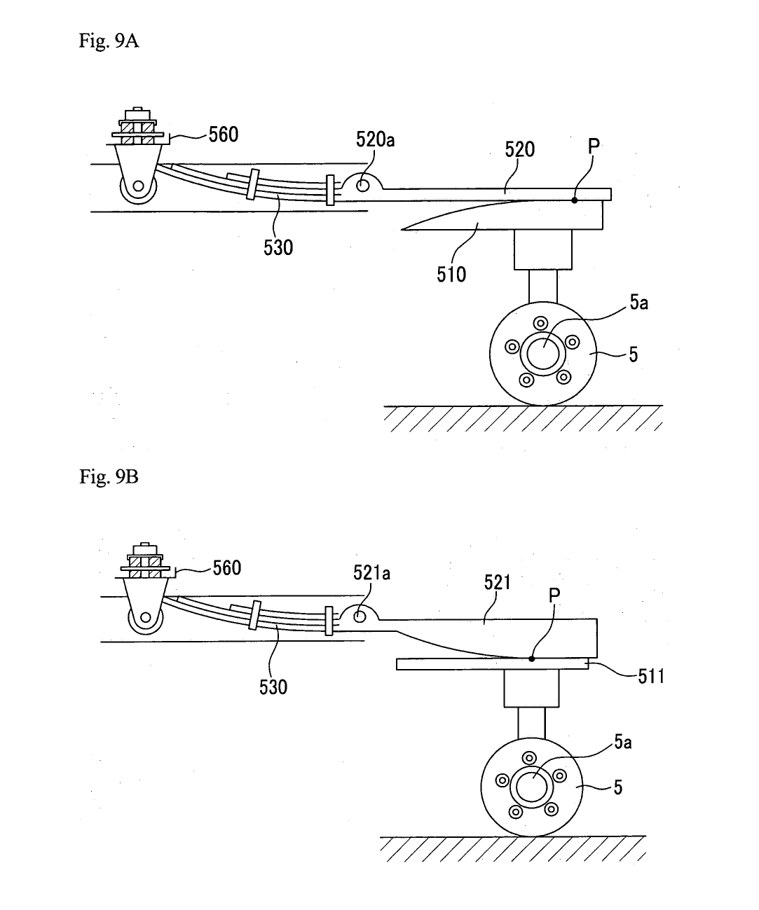

FIGS. 9A and 9B illustrate suspensions using a lever having one end, which is replaced with a leaf spring. As shown in FIG. 9A, a supporter 560 fixed to a chassis of a vehicle induces the absorption of an impact by the spring. When a wheel 5 is rebounded due to the impact, a leaf spring 530 forming a portion of a lever 520 connecting the supporter 560 and a fulcrum 520a absorbs the impact. This suspension has a subsidiary effect of causing the impact applied to one wheel 5 to increase the grounding force of the other wheel. Of course, the upper surface of an impact transmission plate 510 has an upwardly convex shape. Further, FIG. 9B illustrates a suspension modified from the suspension of FIG. 9A. Here, the upper surface of an impact transmission plate 511 is flat and the lower surface of one side of a lever 521 contacting the flat upper surface of the impact transmission plate 511 has a downwardly convex shape.

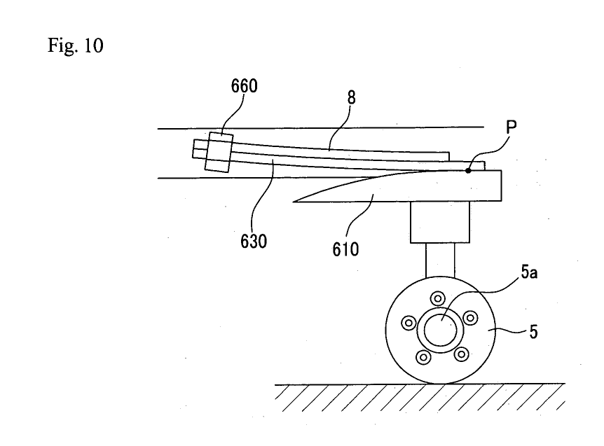

FIG. 10 is a schematic view of a suspension having a simple structure, in which a leaf spring 630 is fixed to a chassis of a vehicle and an impact transmission plate 610 presses directly the leaf spring 630. Of course, the upper surface of the impact transmission plate 610 has an upwardly convex shape.

Although the suspension has any one of the structures, as shown in FIGS. 1 to 10, the more the impact transmission plate is horizontally extended, the shorter the total impact absorbing distance is. Thus, a stabilizer bar for preventing a vehicle from leaning to one side during traveling on a curved road may not be required. That is, the impact absorbing distance is varied according to sizes and shapes of the impact transmission plate.

As apparent from the above description, the present invention provides a suspension using continuous and variable leverage, which exhibits a low spring constant against a weak impact and exhibits a high spring constant against a strong impact, and thus properly copes with various impacts even using a soft spring providing ride comfort with a driver's desired degree, thereby concurrently providing excellent ride comfort and running safety regardless of degrees of the unevenness of a road surface. The suspension of the present invention, which implements the idealist repulsive force, as shown in Graph 2, removes driver's fatigue and increases the endurance of a vehicle compared with any conventional suspension.

Further, the suspension of the present invention, which exhibits repulsive force with the most proper intensity against an impact caused by the unevenness of the road surface in real time, thus having an excellent impact absorbing effect under bad conditions, such as an unpaved road. Accordingly, the suspension of the present invention is the ideal suspension, which is used in an ambulance for relieving pain from a patient during driving or a vehicle loaded with fragile articles. The suspension of the present invention is inexpensive and has a low possibility of trouble compared with an air spring, and thus it is expected that a vehicle provided with the suspension of the present invention has the cost of maintenance lower than that of a vehicle provided with the air spring.

The suspension of the present invention has an excellent ride comfort enhancing effect due to the structure itself. Since a wheel shaft and a rotating shaft (fulcrum) of a lever, to which the weight of a vehicle is transmitted, deviate from a vertical line, an impact transmitted to a chassis of the vehicle is reduced. Thus, since the fulcrum of the lever connected to the chassis of the vehicle comes down toward the ground when a wheel is rebounded, it is possible to compensate for the remaining impact, which is not absorbed by the spring and is transmitted to the chassis of the vehicle. The second effect, i.e., the descent of the chassis of the vehicle, further enhances the ride comfort.

Further, the height of the upper surface of an impact transmission plate for transmitting the impact from the wheel to the lever is gradually decreased close to the fulcrum of the lever, and the closer to the fulcrum of the lever a pressure point is, the shorter the distance between the pressure point and the wheel shaft is. Thus, an effect, as if the vehicle goes over a low protrusion on a road surface, is obtained. This effect is the third factor for enhancing the ride comfort. These factors for enhancing the ride comfort are illustrated in FIGS. 6A to 6B.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A suspension using continuous and variable leverage comprising:
a lever having a fulcrum connected to a chassis of a vehicle;
an impact absorbing part provided with a spring connected to one end of the lever to absorb an impact transmitted through the lever; and
an impact transmission plate located under the other end of the lever, connected to a non-rotating wheel shaft of a wheel, and having an upper surface contacting the lever at a pressure point,
wherein the upper surface of the impact transmission plate has a convex shape toward the lever such that the pressure point can be shifted toward the fulcrum as pressurization is progressed.

2. The suspension according to claim 1, wherein the lower surface of the lever has a downwardly convex shape such that the pressure point can be shifted toward the fulcrum as pressurization is progressed.

3. The suspension according to claim 1 or 2, further comprising a slide plate provided between the lever and the impact transmission plate to reduce friction generated between the lever and the impact transmission plate when the pressure point is shifted toward the fulcrum.

4. The suspension according to claim 1, wherein the impact transmission plate has a disk shape, which surrounds a wheel shaft and is rotatable on the wheel shaft, and removes friction generated between the impact transmission plate and the lever when pressurization is progressed.

5. The suspension according to claim 1, wherein:
the lower end of the impact transmission plate is connected integrally to a non-rotating wheel shaft of a wheel and the upper end of the impact transmission plate is extended upwardly; and
hinge brackets are formed on the bottom of the non-rotating wheel shaft of the wheel, a hinge connection piece hinged to the hinge brackets is formed on the lower end of the impact transmission plate, and an upwardly convex rounded curve part is formed on the upper surface of the impact transmission plate such that the impact transmission plate can be rotated on the wheel shaft and the pressure point can be shifted toward the fulcrum as pressurization is progressed.

6. A suspension comprising:
an impact transmission plate having a lower end connected integrally to a non-rotating wheel shaft of a wheel and an upper end extended upwardly;
a housing supporting a spring and a fulcrum of a lever, and having an outer surface fixed to a chassis of a vehicle; and
the lever having one end, the lower surface of which contacts the impact transmission plate, and transmitting the weight of the chassis to the ground through the fulcrum formed at the center of the lever,
wherein a rounded curve part is formed on the upper surface of the impact transmission plate such that a pressure point between the impact transmission plate and the lever can be shifted toward the fulcrum as pressurization is progressed.

7. The suspension according to claim 6, wherein the lower surface of the lever has a downwardly convex shape such that the pressure point can be shifted toward the fulcrum as pressurization is progressed.

8. A suspension comprising:
an impact transmission plate having a lower end connected integrally to a non-rotating wheel shaft of a wheel and an upper end extended upwardly;
a housing supporting a spring and a hinge shaft, and having an outer surface fixed to a chassis of a vehicle; and
a hinge bar having one end, the lower surface of which contacts the impact transmission plate, and the other end having a hinge shaft hinged thereto,
wherein a rounded curve part is formed on the upper surface of the impact transmission plate such that a pressure point between the impact transmission plate and the hinge bar can be shifted toward the hinge shaft as pressurization onto the hinge bar is progressed.

9. The suspension according to claim 8, wherein the lower surface of the hinge bar has a downwardly convex shape such that the pressure point can be shifted toward the hinge shaft as pressurization onto the hinge bar is progressed.

10. The suspension according to claim 8, wherein the impact transmission plate connected directly to the spring and being convexly rounded toward the hinge bar; and
a supporter allowing the impact transmission plate only to move rectilinearly,
wherein a contact point between the hinge bar and the impact transmission plate becomes distant from a hinge shaft, when an impact transmitted from a wheel presses the hinge bar.

11. The suspension according to claim 10, wherein one surface of the hinge bar contacting the impact transmission plate has a convex shape.

12. A suspension comprising:
an impact transmission plate having a lower end connected to a wheel shaft or a leaf spring and an upper end extended upwardly;
a lever having one end, the lower surface of which contacts the impact transmission plate, and provided with a fulcrum formed at the center of the lever and connected to a chassis of a vehicle to transmit the weight of the vehicle to the ground; and
the leaf spring connected to the lower surface of the other end of the lever by a hanger and fixed to the chassis,
wherein the upper surface of the impact transmission plate 410 has a convex shape toward the lever such that a pressure point between the impact transmission plate and the lever can be shifted toward the fulcrum as pressurization onto the lever is progressed.

13. A suspension comprising:
a lever having a fulcrum connected to a chassis of a vehicle to support the weight of the vehicle;
an impact transmission plate contacting one end of the lever;
a leaf spring forming the other end of the lever; and
a supporter fixed to the chassis of the vehicle to support the tip of the leaf spring,
wherein the upper surface of the impact transmission plate has an upwardly convex shape such that a pressure point between the impact transmission plate and the lever can be shifted toward the fulcrum as pressurization onto the lever is progressed.

14. The suspension according to claim 13, wherein the lower surface of the lever has a downwardly convex shape such that the pressure point can be shifted toward the fulcrum as pressurization onto the lever is progressed.

15. A suspension comprising:
a leaf spring having one end fixed to a chassis of a vehicle by a supporter; and
an impact transmission plate located under the other end of the leaf spring, connected to a non-rotating wheel shaft of a wheel, and having an upper surface having a contact point with the leaf spring,
wherein the upper surface of the impact transmission plate has an upwardly convex shape such that the contact point can be shifted toward the supporter as pressurization is progressed.
